(19) United States
(12) Patent Application Publication
(10) Pub. No.: US 2025/0223999 A1
(43) Pub. Date: Jul. 10, 2025

(54) SHAPE MORPHING STRUCTURES

(71) Applicant: UNIVERSITY OF SOUTH FLORIDA, Tampa, FL (US)

(72) Inventor: Craig Lusk, Tampa, FL (US)

(21) Appl. No.: 19/011,508

(22) Filed: Jan. 6, 2025

Related U.S. Application Data
(60) Provisional application No. 63/617,476, filed on Jan. 4, 2024.

(51) Int. Cl. F16C 11/04; B64C 3/54

(52) U.S. Cl. CPC F16C 11/04; B64C 2003/543

(57) ABSTRACT

A structure, devices comprising such structures, methods and systems for designing structures is provided. As an example, a structure may include a plurality of first type members, each first type member corresponding to a respective first type vertex of an underlying aperiodic tiled lattice; a plurality of second type members, each second type member corresponding to a respective second type vertex of the underlying aperiodic tiled lattice; and a plurality of revolute joints corresponding to respective edges of the underlying aperiodic tiled lattice and connecting respective joint parts of pairs of members, each pair comprising a first type member and a second type member; wherein: each respective revolute joint is located, with respect to a local position of the respective edge, at a first common normalized vector with respect to a local position of the respective first type vertex and at a second common normalized vector with respect to a local position of the respective second type vertex.

### CROSS-REFERENCE TO RELATED APPLICATIONS

This application claims priority to U.S. provisional patent application No. 63/617,476, filed Jan. 4, 2024, the entire contents of which are incorporated herein by reference

### STATEMENT REGARDING FEDERALLY SPONSORED RESEARCH OR DEVELOPMENT

N/A

### BACKGROUND

In general, shape morphing structures comprise arrays of linkages that coordinate the shape of an object, as well as various functional units specific to the application. Shape morphing structures may be used in various applications, such as to optimize wing profiles in aerospace applications, as deployable mechanisms for satellites' solar panel arrays, and morphing buildings to reduce wind loads.

Penrose tiles are a way of tiling a plane in a non-periodic fashion. A plane tiling is a systematic way of subdividing a plane into subunits that completely fill the plane and leave no gaps. Regular tilings use a single standard shape that is repeated in one of seventeen standard tilings, called wallpaper tilings. These standard shapes are derived based on parallelograms. Regular tilings use mirror symmetries, translations, glides, and rotations of R2=180°, R3=120°, R4=90°, and R6=60°.

Regular tilings about a point with 5th order rotational symmetry, R5=72° do not exist. Penrose tiles do have local 5th order rotational symmetry, but do not form periodic tilings. Further, they use two standard shapes (a kite and a dart) instead of just one. The kite and the dart are complementary parts of a rhombus with a corner angle of 72°, and side lengths with ratios (1+√5)/2.

Kites and darts must be composed in specific ways to tile the plane non-periodically. One way of representing this specification is to place colored nodes on compatible corners of the kite and the dart. Thus, each side has a white node on one end and a black node on the other. This leads to only seven valid ways of arranging kites and darts around a particular node (3 around white nodes, 4 around black nodes), these arrangements, called vertex clusters, have been given specific names: the white Star, the white Ace, the white King, the white Queen; the black Sun, the black Deuce, and the black Jack.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

In some aspects, the present discloser may provide a structure, devices comprising such structures, methods and systems for designing structures. As an example, a structure may include a plurality of first type members, each first type member corresponding to a respective first type vertex of an underlying aperiodic tiled lattice; a plurality of second type members, each second type member corresponding to a respective second type vertex of the underlying aperiodic tiled lattice; and a plurality of revolute joints corresponding to respective edges of the underlying aperiodic tiled lattice and connecting respective joint parts of pairs of members, each pair comprising a first type member and a second type member; wherein: each respective revolute joint is located, with respect to a local position of the respective edge, at a first common normalized vector with respect to a local position of the respective first type vertex and at a second common normalized vector with respect to a local position of the respective second type vertex.

An example method for designing a structure may include obtaining a description of an underlying aperiodic tiled lattice; determining a structure shape corresponding to at least a portion of the underlying aperiodic tiled lattice; selecting a plurality of first type vertexes of the underlying aperiodic tiled lattice for a plurality of first type members; selecting a plurality of second type vertexes of the underlying aperiodic tiled lattice for a plurality of second type members; locating a plurality of revolute joints to connect respective joint parts of pairs of members, each pair comprising a first type member and a second type member, the plurality of revolute joints corresponding to respective edges of the underlying aperiodic tiled lattice; wherein each respective revolute joint is located, with respect to a local position of the respective edge, at a first common normalized vector with respect to a local position of the respective first type vertex and at a second common normalized vector with respect to a local position of the respective second type vertex; and generating a design of a structure comprising the first type members and second type members connected by the plurality of revolute joints

In further aspects, the present disclosure can provide a method for modeling the motion of such structures or devices including such structures. For instance, an example modeling method may include identifying a plurality of RRRP-type kinematic loops of the structure; identifying a reference kinematic loop of the plurality of RRRP-type kinematic loops comprising a first reference vertex of the underlying aperiodic tiled lattice associated with a first type reference member, a second reference vertex of the underlying aperiodic tiled lattice associated with a second type reference member and a reference revolute joint connecting the first type reference member and the second type reference member; identifying a rotation parameter for at least a subset of the plurality of RRRP-type kinematic loops with respect to the reference kinematic loop; identifying translation parameters for at least a subset of the members of the plurality of RRRP-type kinematic loops with respect to the first type reference member or the second type reference member; and modeling kinematics of the structure based on the reference kinematic loop, the rotation parameters, and the translation parameters.

### BRIEF DESCRIPTION OF THE DRAWINGS

The features of embodiments will be more readily understood by reference to the following detailed description, taken with reference to the accompanying drawings, in which:

FIGS. 1A-F illustrate various aspects of an example shape morphing structure.

FIG. 2 illustrated example shapes of structural members compatible with an underlying dart-and-kite Penrose lattice.

FIG. 3 illustrates an example shape-morphing structure.

FIG. 4 illustrates an example shape-morphing structure.

FIGS. 5A-B illustrate multiple tiling orders of an underlying aperiodic lattice.

FIGS. 6A-B illustrate various aspects of an example shape-morphing structure.

FIGS. 7A-B illustrate various kinematic aspects of an example shape-morphing structure.

FIGS. 8A-B provide photographs of an example prototype shape-morphing structure.

FIG. 9 illustrates an example device including a shape-morphing structure.

FIG. 10 illustrates an example shape-morphing structure design system.

FIG. 11 illustrates an example computer architecture to execute a shape-morphing structure design system.

### DETAILED DESCRIPTION

Aspects of the described technology may provide quasi-periodic, plane-filling, tessellated mechanism structures and techniques for designing such structures. Such structures may be of value in the creation of shape-morphing objects for aerospace, deployment and storage, wind-load mitigation, medical devices, etc. In some examples, the tessellation technique may be derived from a Penrose tiling using angular-velocity-colored mechanism graphs. This technique allows the identification of a Penrose tiling with the graph of a redundantly constrained parallel mechanism. A general design technique is presented as well as a specific example structures. For Penrose tiles, the method produces seven distinct types of links that can be configured to move relative to each other and be tessellated with arbitrarily many links. As the mechanism array moves, the Penrose tiling lattice changes size and rotates but does not distort.

Various examples are described herein with respect to mechanism graph terminology. Graph theory is a branch of mathematics concerned with representing relationships between objects: a graph consists of nodes (the objects) and edges (the relationships). In mechanism graphs, links are represented by nodes and joints are represented by edges. Additional information about the objects can be added by labels on edges or nodes. Graph coloring is a visually striking way of asserting that nodes are similar (the same color) or different (different colors). In mechanism graphs, using the same color for links that have the same angular velocity (throughout actuation) provides a visual way of capturing motion dependencies. Simply put, in a mechanism without redundancies of any kind, the number of node colors (different angular velocities) equals the number of links in the mechanism. On the other hand, when a mechanism has fewer colors in its graph than links, the link lengths in the mechanism are not independent. Thus, a colored mechanism graph can be used to specify classes of mechanisms with special geometry. As a mode of explanation, various examples may be described with respect to this nomenclature. For ease of explanation, a first type may be described as “white” and a second type may be described as “black.” Further, members may be described as “links”. Accordingly, example structure 100 may be described as comprising white links 101, 103, 105, 107, 109, 111, 113, 115, 117, 119 corresponding to white vertices (e.g., 131, 132, 133, 135, 137, 139), and black links 102, 104, 106, 108, 110, 112, 114, 116, 118, 120 corresponding to black vertices (e.g., 132, 136, 138, 134, 140).

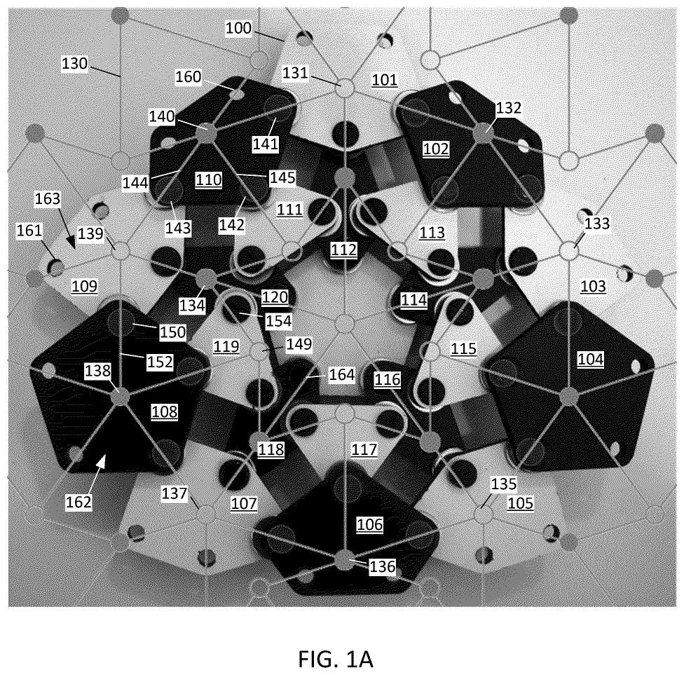

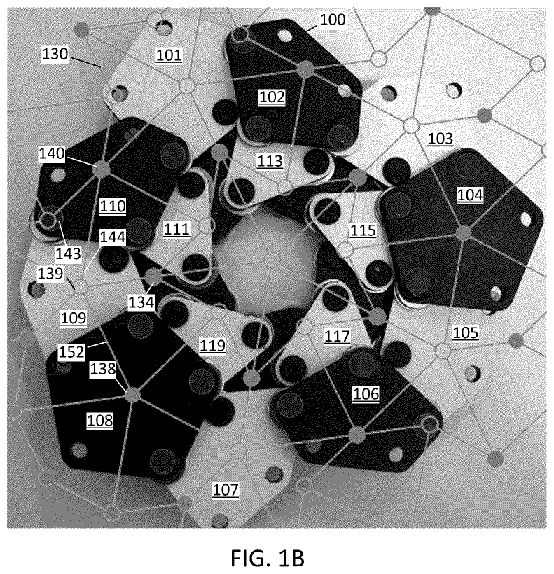

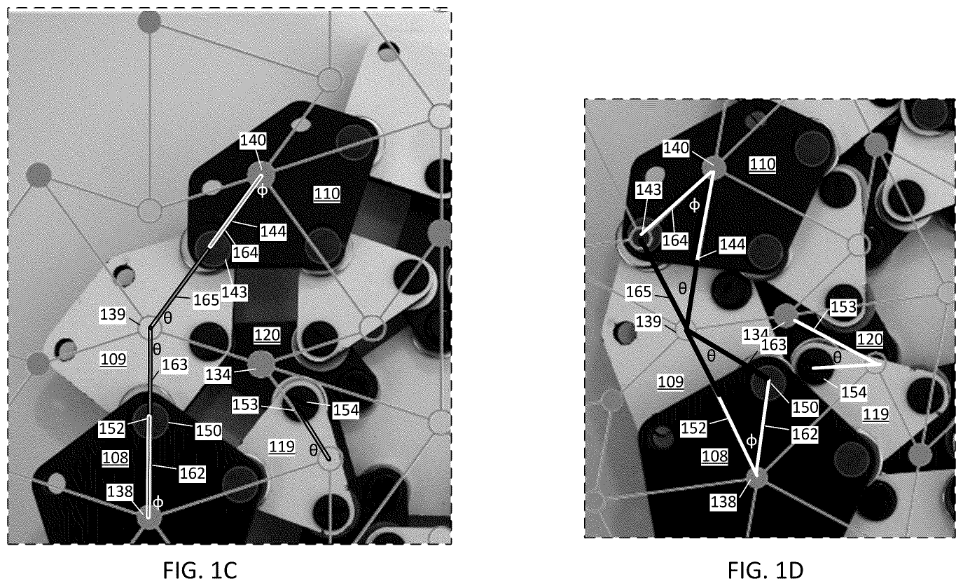

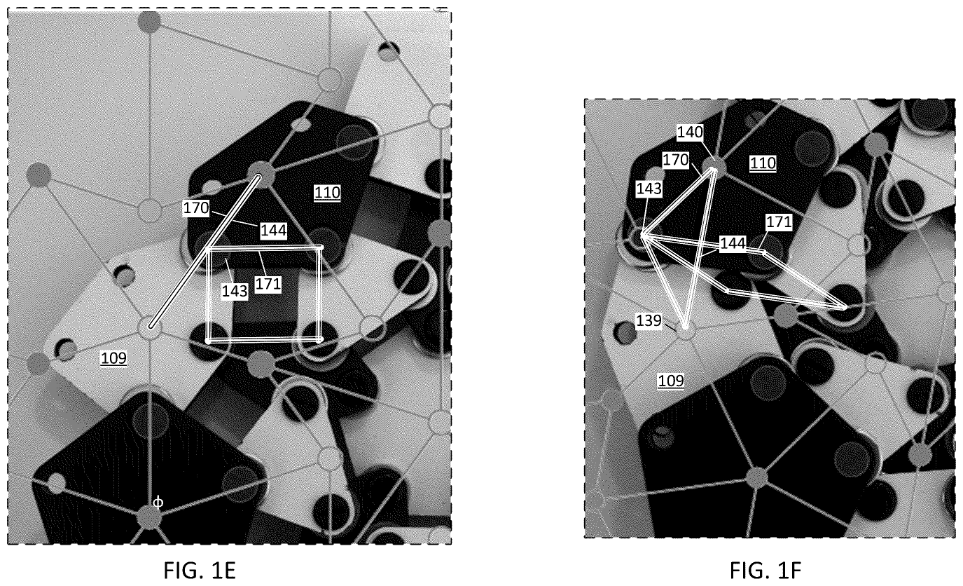

FIGS. 1A-F illustrate an example shape-morphing structure 100 illustrating aspects of the described technology. As illustrated, structure 100 comprises members 101-120 connected by revolute joints (e.g., joints 121, 142, 143, 150, 154). Members 101-120 correspond to vertexes of underlying aperiodic tiled lattice 130. As illustrated, the underlying lattice 130 is not necessarily physical but rather reflects the arrangement and connectivity of the structure 100. Structure 100 may be actuated between an expanded configuration (FIG. 1A, 1C) and a contracted configuration (FIG. 1B, 1D).

Example structure 100 comprises a plurality of first type members (odd numbered references 101, 103, 105, 107, 109, 111, 113, 115, 117, 119) and a plurality of second type members (even numbered references 102, 104, 106, 108, 110, 112, 114, 116, 118, 120). Here, each first type member corresponds to a respective first type vertex (e.g., example vertices 131, 132, 133, 135, 137, 139) of the underlying aperiodic tiled lattice 130. Similarly, each second type member corresponds to a respective second type vertex (e.g., example vertices 132, 136, 138, 134, 140) of the underlying aperiodic tiled lattice. For example, the first and second type vertices may correspond to a potential node coloring of the underlying lattice 130. For ease of explanation, the first type may be described as “white” and the second type may be described as “black.” Further, members may be described as “links”. Accordingly, example structure 100 may be described as comprising white links 101, 103, 105, 107, 109, 111, 113, 115, 117, 119 corresponding to white vertices (e.g., 131, 132, 133, 135, 137, 139), and black links 102, 104, 106, 108, 110, 112, 114, 116, 118, 120 corresponding to black vertices (e.g., 132, 136, 138, 134, 140).

Example structure 100 further comprises plurality of revolute joints (examples 141, 142, 143, 150, 154, connecting respective joint parts (160, 161) of pairs of members. The revolute joints may correspond to respective edges (e.g., 144, 145, 152) of the underlying aperiodic tiled lattice 130. In some examples, each respective revolute joint is located, with respect to a local position of the respective edge, at a first common normalized vector with respect to a local position of the respective first type vertex and at a second common normalized vector with respect to a local position of the respective second type vertex. For example, such positioning of resolute joints (e.g., angle w.r.t to a local x-axis, and distance w.r.t a local origin, scaled by the distance between vertices) may preserve a parallel mechanism structure (see, e.g., FIGS. 1E-F, 3B).

For example, as illustrated in FIGS. 1C and 1D, joint 143 may be associated with a vector 164 connecting joint 143 and vertex 140 and may be associated with a vector 165 connecting joint 143 and vertex 139. Similarly, joint 150 may be associated with a vector 163 connecting joint 150 and vertex 139 and may be associated with a vector 162 connecting joint 150 and vertex 138. In this example, black vectors 164 and 162 share a common angle (ϕ) with respect to their respective corresponding vertices 140, 138 and edges 144, 152. Similarly, white vectors 165, 163 share a common angle (θ) with respect to their respective corresponding vertex 139 and edges 144, 152. When normalized by the distance between connected vertices, white vectors share a first common length and black vectors share a second common length.

In some examples, the revolute joints of a structure 100 may remain self-similar with respect to an underlying lattice 130 while the structure 100 contracts and expands. For example, as illustrated in FIGS. 1A and 1B, the illustrated example structure 100 contracts such that the underlying lattice 130 is rotated and its edge lengths are uniformly contracted. During actuation, the revolute joints may maintain their relative positioning as described above. For instance, in the illustrated example, angles ϕ and θ increase uniformly during actuation from the expanded configuration illustrated in FIG. 1C to the contracted configuration illustrated in FIG. 1D. Accordingly, structure 100 may comprise an arrangement of members that has a single degree-of-freedom (DoF) in its expansion/contraction.

As described further below, this motion may be described with respect to actuation of RRRP loops (where R refers to a revolute joint and P refers to a prismatic joint) and RRRR loops. For example, FIGS. 1E, 1F illustrate RRRP loop 170 and RRRR loop 171. Here, RRRP loop 170 represents movement of joint 143 with respect to vertex locations 140, 139 of members 110 and 109 with the edge 144 representing the prismatic joint of the RRRP loop (e.g., edge 144 decreases in length from the expanded configuration to the retracted configuration). RRRR loop 171 represents a parallel four bar linkage formed by corresponding revolute joints connecting members 109, 110, 111, 120. Again, the vertex points and edges of the underlying lattice 130 are not necessarily physical and RRRP loop 170 provide a description of the movement of the members. However, RRRR loop 171 represents a physical parallel four bar kinematic chain. Accordingly, the actuation of structure 100 may incorporate the motion of a plurality of redundant parallel linkages.

In some cases, such redundancy may provide some degree of damage tolerance to structures implemented in accordance with the described technology. In some cases, structures may maintain structural integrity despite a number of joint breakages that disconnect neighboring members (e.g., flexure breakage with flexure-type revolute joints). In some cases, the aperiodic/fractal positioning of the revolute joints may provide a degree of failsafe protection. For instance, this positioning may avoid straight line arrangements of revolute joints and distribute stresses from linear forces.

In some examples, structures may be designed according to underlying Penrose tiling diagrams, not only as non-periodic tilings, but as two-color mechanism graphs. Because each kite and dart has two white nodes and two black nodes, each can be interpreted as specifying a parallel four-bar mechanism. Because each edge of a mechanism graph can represent a revolute joint (e.g., pin joints, flexures, etc.), the design may include locating joints in a consistent way relative to the Penrose tiling. For example, one version is to place the pin joint halfway between the white and black node on each side. Defining members/links by the set of all pin joints adjacent to a node produces a consistent set of shapes for the white king, white queen, white star, white ace, black deuce, black jack and black sun. Consistently varying the location of the revolute joint relative to white and back nodes changes the relative size of the white links to the black links and their initial orientation but does not change their shape.

At each revolute joint of each link, there is a specific angle formed by a line from each pin hole to the adjacent pin holes on the link. These angles partially govern which pin holes can be connected in the different links. Example assembly rules for these shapes are inherited from those of the Penrose tiles but may be expressed differently: (1) white links are connected only to black links, and vice versa; and (2) the angle at the pinhole of a white link must be complementary (sum to π/180°) to the angle at pinhole of the black link. For example, a design process may include obtaining an arbitrarily shaped consistent lattice (e.g., from a plane-filling array constructed using kite/dart matching rules, fractal symmetry and adding a kite or dart only where the placement is uniquely specified). The design process may further include locating joints placement consistently to construct a structure. Table 1 lists each link type, its angles and which other links are locally compatible.

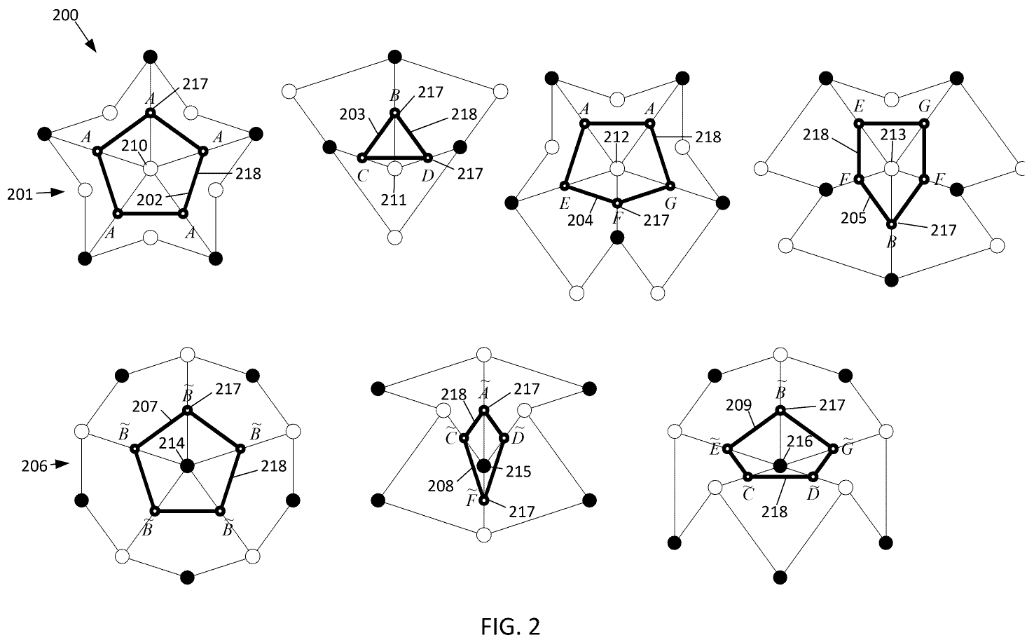

FIG. 2 illustrates an example set 200 of compatible members 202, 203, 204, 205, 207, 208, 209 corresponding to valid kite-and-dart Penrose tile vertex arrangements. In this example, a set 201 of first type (e.g., white) members 202, 203, 204, 205 corresponds to a “star” vertex 210, an “ace” vertex 211, a “king” vertex 212, and a “queen” vertex 213, respectively. A set 206 of second type (e.g., black) members 207, 208, 209 corresponds to a “sun” vertex 214, a “deuce” vertex 215, and a “jack” vertex 216, respectively. For ease of explanation, members 202-205, 207-209 may be referred to by these corresponding vertexes (e.g., a “star member” 202, etc.). The below Table lists each link type, its angles and which other links are locally compatible. Joint compatibility is indicated by a pair with same letter, one with a tilde, the other without (e.g. A, A). Also, though the angles are the same for the pairs (C, D) and (E, G), these are not mutually compatible, as the kite and dart pair forming these joints has chirality (or handedness, e.g. kite on left, dart on right). Joints located on the edge of dart-dart or kite-kite pairs are achiral.

TABLE 1

| | | Compatible |
|---|---|---|
| Link Type | Angle Set | Link Types |
| White Star | A = 108° (5x) | Deuce |
| White Ace | B = 72°, C = D = 54° | Sun, Jack, Deuce |
| White King | A = 108° (2x), | Jack, Deuce |
| | E = G = 90°, F = 144° | |
| White Queen | B = 72°, F = 144° (2x), | Sun, Jack, Deuce |
| | E = G = 90° | |
| Black Sun | \tilde{B} = 108° (5x) | Star, Queen |
| Black Deuce | Ã = 72°, \tilde{C} = \tilde{D} = 126°, | Star, Ace, King, |
| | \tilde{F} = 36° | Queen |
| Black Jack | \tilde{B} = 108°, \tilde{C} = \tilde{D} = 126°, | Ace, King, Queen |
| | \tilde{E} = \tilde{G} = 90° | |

In various implementations, structures may be constructed using all or any compatible subset of these member types. In some examples, while each member type need not present, any star member (e.g., each star member, if any) may be connected to some deuce member; any ace member may be connected to some sun member, some jack member, or some deuce member; any king member may be connected to some jack member or some deuce member; any queen member may be connected to some sun member, some jack member, or some deuce member; any sun member may be connected to some star member or some queen member; any deuce member may be connected to some star member, some ace member, some king member, or some queen member; and any jack member may be connected to some ace member, some king member, or some queen member.

For instance, a structure might be constructed using only star members 202 and deuce members 208. As another example, a structure might be constructing using only ace members 203, jack members 209, and queen members 205. As illustrated in FIG. 1A, structure 100 lacks a star member 202 and includes a queen member 101, a jack member 102, a queen member 103, a sun member 104, a queen member 105, a jack member 106, a queen member 107, a sun member 108, a queen member 109, a jack member 110, an ace member 111, a deuce member 208, an ace member 113, a deuce member 114, an ace member 115, a deuce member 116, an ace member 117, a deuce member 118, an ace member 119, and a deuce member 120. As an example of the compatibility described in Table 1, each ace member 111, 113, 115, 117, 119 is connected to some deuce member 112, 114, 116, 118, 120, some jack member 110, 103, 106, or some sun member 108, 104 (e.g., ace member 111 is connected to deuce members 112, 120 and jack member 110; ace member 115 is connected to deuce members 114, 116 and sun member 104, etc.).

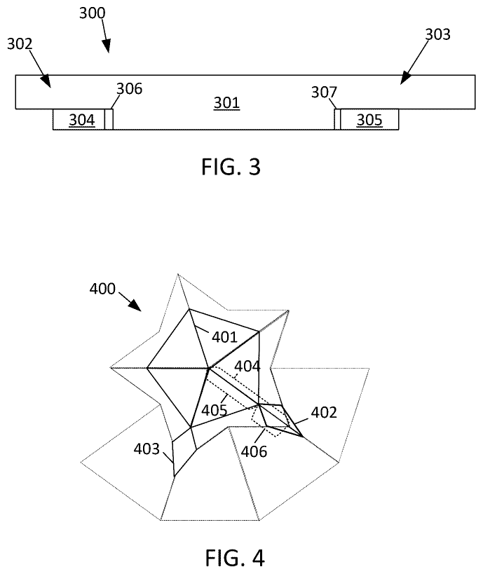

In various implementations, members may have any physical structure that includes parts for revolute joints located at compatible positions (e.g., holes for pin joints, hinges for hinged joints, flexure connection points, etc.). For instance, members 101-120 illustrated in FIG. 1 comprise tiles having holes 160, 161 for pin joints and continuous material 162, 163 spanning region bounded by the revolute joints. As another example, members 202-205, 207-209 comprise frames 218 connecting pin joints 217. In further examples, members may include material that projects outside the area bounded by their revolute joints. For example, FIG. 3A illustrates a side view of an example structure 300 comprising members 301, 304, 305. In this example, member 301 includes material portions 302, 303 extending beyond the region bounded by revolute joints 306, 307. Accordingly, member 301 partially overlaps members 304, 305. Of course, a given member need not have every potential revolute joint location occupied or even present. For instance, in an example such as structure 100, some members may be provided without the unused pin holes on the outer periphery (e.g., 160, 161) and inner periphery (e.g. 165). For example, such members may have physical structure providing a rigid location only used revolute joint locations.

As described above, resolute joints may be located at consistent normalized vectors with respect to corresponding vertices of an underlying graph. For example, in the examples illustrated in FIGS. 1A-F and 2, the vectors are located at the midpoint of underlying graph edges. Accordingly, in these examples, the normalized vectors for the first type members have the same length as the normalized vectors of the second type members (e.g., normalized to 50%). However, in further examples, revolute joints may be located such that first type members and second type members have different normalized vector lengths. For instance, FIG. 4 illustrates an example portion of a structure comprising a star member 401 (e.g., a first type member comprising a frame and spokes connecting revolute joint locations) and two deuce members 402 (comprising a frame connecting revolute joint locations), 403 (comprising a tile connecting revolute joint locations). In this example, the normalized vector 405 is 75% the length of vector 404 between the members corresponding vertices. Similarly, normalized vector 406 is 25% the length of vector 404. Accordingly, structures implemented as described herein may include first type members having a first characteristic scale and second type members having a second characteristic scale.

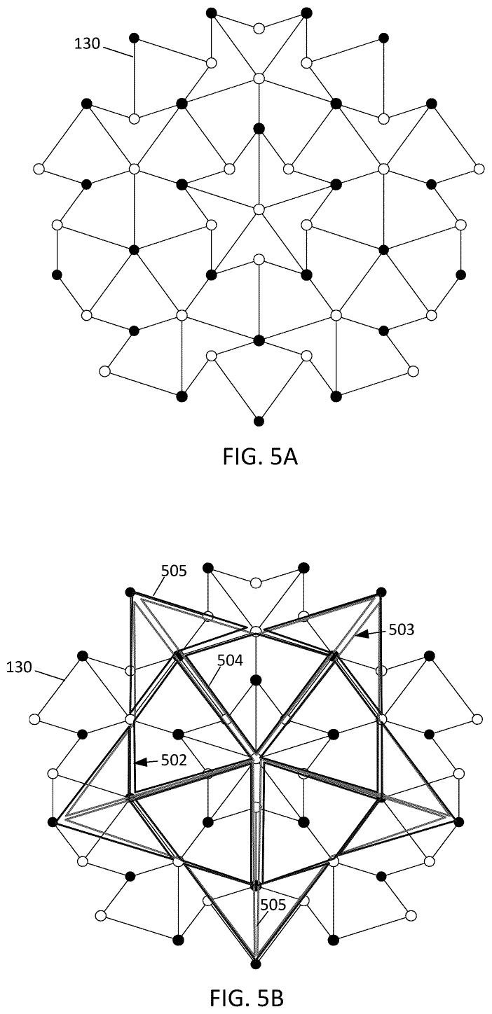

In some examples, members may correspond to different orders of tiling of an underlying lattice. For example, a Penrose kite-and-dart tiling may comprise multiple orders that are each ϕ times larger (where ϕ=(1+√5)/2) than the previous order. As an illustration, FIG. 5A shows the underlying Penrose lattice 130 of structure 100. FIG. 5B illustrates a second order tiling 502 that is ϕ time larger than the first order tiling (e.g., FIG. 5A) and a third order tiling 503 that is ϕ² times larger than the first order tiling. Here, the second order tiling 502 comprises a sun 504 surrounded by kites 505 and the third order tiling 503 comprises a star 505. Further, as this example illustrates, vertices may be of different types based on the tiling order.

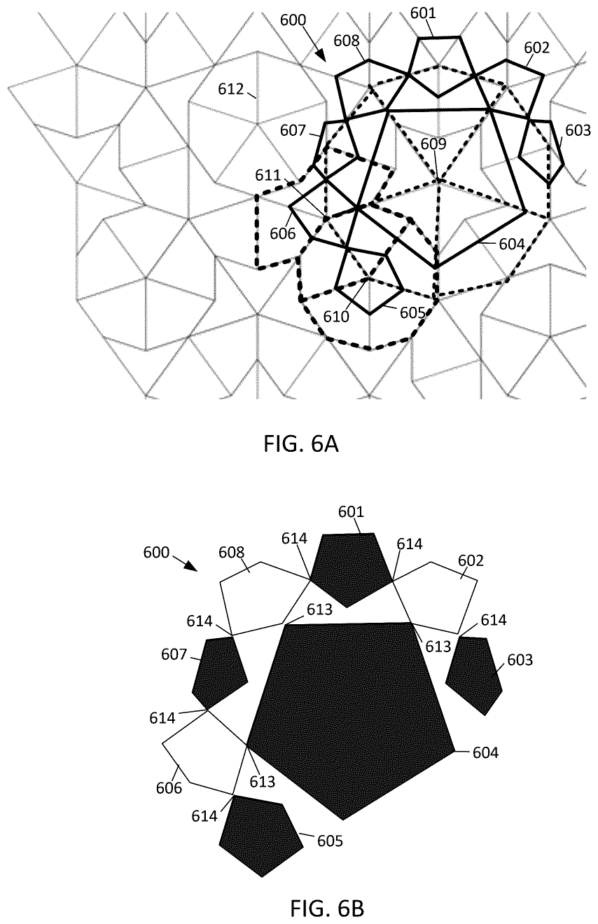

FIGS. 6A and 6B illustrate an example structure 600 comprising members of multiple orders. FIG. 6A illustrates an outline of the structure 600 with a corresponding underlying lattice 612 and FIG. 6B illustrates the structure 600 without the underlying lattice. Here, structure 600 comprises a second order sun member 604 corresponding to vertex 609 (which is a sun vertex in the second order and a star vertex in the first order). Structure 600 further comprises a plurality of first order members 601, 602, 603, 605, 606, 607, 608. In FIG. 6A the second order sun (vertex 609), the first order sun (vertex 610), and the first order queen (vertex 611) are outlined. In this example, revolute joints 613, 614 connecting members are located at positions consistent with their orders and compatibility conditions. For example, revolute joints 613 are located at positions compatible with the first and second order tilings while revolute joints 614 are located at positions compatible with the first order tiling.

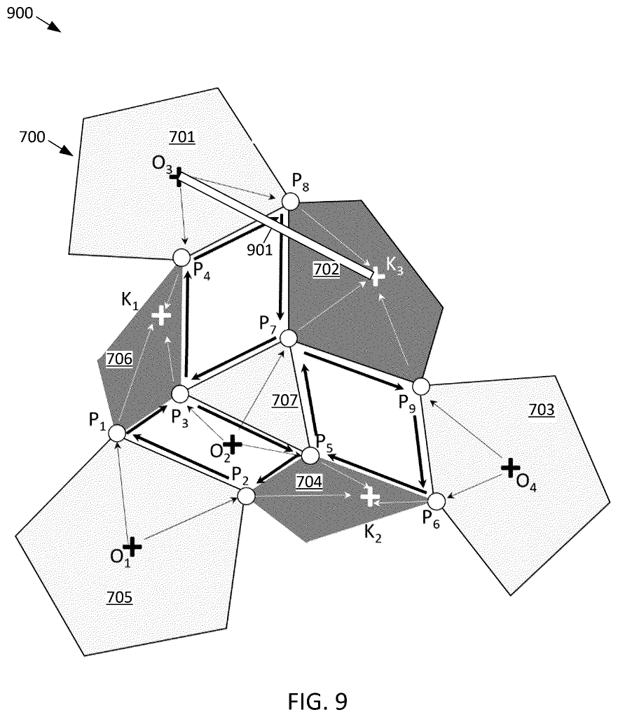

A prototype of the Penrose-Tile Shape-Morphing-Mechanism-Array was prototyped using laser-cut links that were bi-color (one side white, one side black) to illustrate the motion and different link types. FIG. 9a shows the array in its largest configuration, and FIG. 9b show the array in the most compressed configuration allowed by this construction method, with the motion limit coming from link interference after the white links have rotated 58° counterclockwise relative to the black links, and 29° degrees counterclockwise relative to the lattice (shown in blue). The lattice shrinks in proportion to the cosine of the angle of rotation of the links with respect to the lattice. Thus, the larger configuration is 8.3 cm from the center of the white star to the centers of the black suns. The smaller configuration is 7.3 cm=8.3 cos (29°) between the same points. Thus, the area change provided from smallest to largest size is approximately 30%.

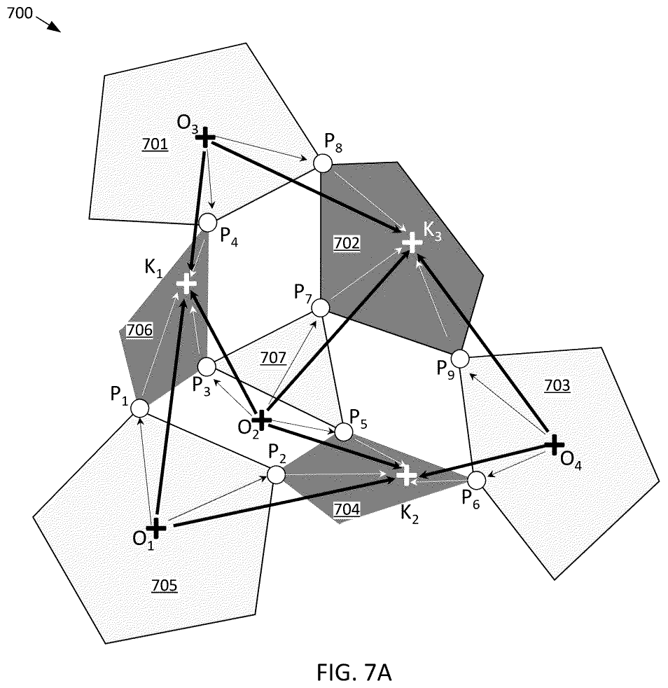

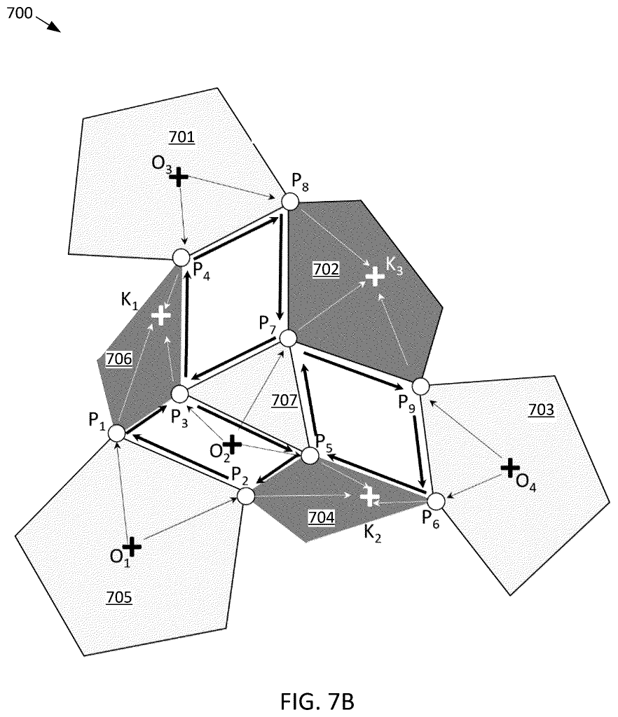

FIGS. 7A and 7B illustrate example kinematic aspects of an example structure 700. Although structures described herein have many different possible versions and implementations, these configurations are built from simpler members consistent with an underlying aperiodic tiled lattice (e.g., kites and darts), which allows for a simple adequate description of the motion of the array. FIG. 7A shows the vector loops associated with a white ace member 707 and surrounding members 701-706 (aka “links”). The portion of the Penrose array associated with these members are a dart and two kites. Each member 701-709 in this portion of the array has a lattice point marked with a ‘+’. The white lattice points are labeled with an ‘O’ and a subscript number, i. The black lattice points are labeled with a ‘K’ and a subscript j. For ease of explanation, the member color matches the node type: white members for white nodes (aces, stars, queens, kings) and black members for black nodes (suns, deuces, jacks). The lattice point marks, ‘+’, are the opposite color for contrast. The vector loop for each edge of the lattice consists of a vector connecting a white lattice point, Oᵢ, to a black lattice point, Kⱼ, and vectors connecting these two lattice points to the revolute joint (e.g., a pin joint), Pₗ, connecting the white and black links. The lattice point is a fixed location with respect to each link, and the vectors from lattice point to the pin joint are of constant length. The vector OᵢKⱼ between the lattice points changes length when the links rotate. Thus, these vector loops (vectors OᵢPⱼA, PⱼKₗ, OᵢKₗ) are automorphic to planar RRRP linkage (crank-slider) vector loops. These vectors inherit certain properties from the kite and dart elements, specifically, as the kite and darts are composed of two lengths with ratios of 1:0, the vector loops in FIG. 7A have the same scaling (e.g. ϕ|O₂K₁|=|O₁K₁|, ϕ|O₂P₃|=|O₁P₁|, etc.).

The parallel four-bar vector loops shown in FIG. 7B ensure that all the white links rotate with the same angular velocity and all the black links rotate with the same angular velocity respectively. Thus, all the vector loops OᵢPⱼKₗ are synchronized, meaning that if one such loop is computed, the length and rotation of vectors in a different OᵢPⱼKₗ loop can be found by multiplying by a constant complex number z=ωe^{iψ}.

For example, taking O₁P₁K₁ as the reference loop, the vectors in loop O₁P₂K₂ can be found using ζ=1, ψ=288°, because the O₁P₂K₂ loop is the same size and is rotated 72° clockwise with respect to the O₁P₁K₁ loop. Continuing with O₁P₁K₁ as the reference loop means that for every such loop ζ=1 or 1/ϕ (2 possibilities), and vis a multiple of 36 degrees (10 possibilities). The OᵢPⱼKₗ loop is sufficient to define the motion of all the white links 707, 701, 703, 705 (synchronized with vectors OᵢPⱼ), all the black links 702, 074, 706 (synchronized with vectors PⱼKₗ), relative to the underlying Penrose tiling lattice (synchronized with vectors OᵢKₗ). Thus, modeling the kinematics of an arbitrarily large structure may be performed by computing the motion of a single OᵢPⱼKₗ loop, finding the complex factor, z, for each additional loop (yielding the rotation of link), and computing vector sums to determine the translation of each link.

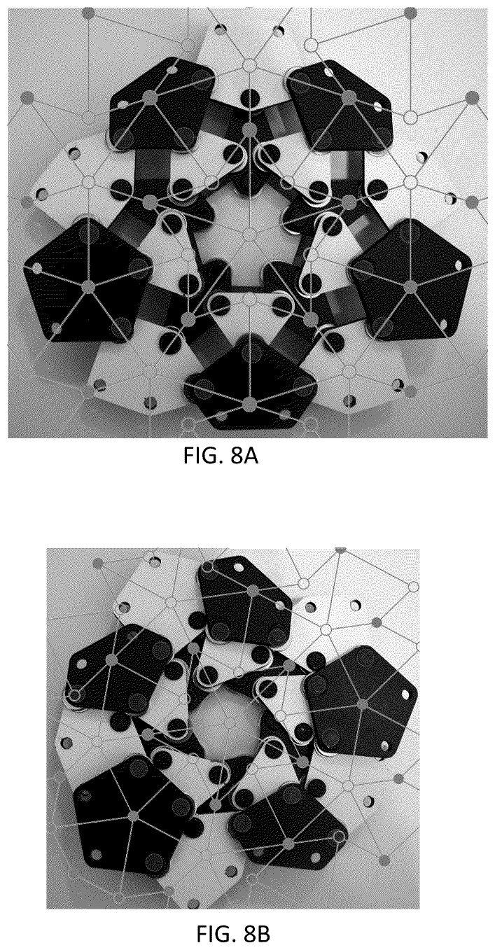

FIGS. 8A-B are photographs of a prototype of a Penrose-tile shape morphing mechanism array prototyped using laser-cut links that were bi-color (one side white, one side black) to illustrate the motion and different link types. FIG. 8A shows the array in its largest configuration, and FIG. 8B show the array in the most compressed configuration allowed by this construction method, with the motion limit coming from link interference after the white links have rotated 58° counterclockwise relative to the black links, and 29° degrees counterclockwise relative to the lattice. The lattice shrinks in proportion to the cosine of the angle of rotation of the links with respect to the lattice but does not distort. Thus, the larger configuration is 8.3 cm from the center of the white star to the centers of the black suns. The smaller configuration is 7.3 cm≈8.3 cos (29°) between the same points. Thus, the area change provided from smallest to largest size is approximately 30%. In the prototype, each kite and separately each dart contains the same geometry (exceptions are due to link layering and array boundaries).

For purposes of illustration, various example structures have been illustrated as generally planar, single layered designs. However, structures may be combined to form various three-dimensional structures. For example, a device may comprise multiple layers of structures coupled to move in parallel (e.g., a cylinder, cube, or any arbitrary volume comprising a stack of structures). Various devices of any scale may be manufactured using members as described herein. As described herein, the structures may be self-similar at any degree of expansion, and may thus have a functional shape at any expanded/retracted configuration. For example, structures as described herein may serve as components of shape-morphing objects for aerospace, deployment and storage, wind-load mitigation, medical devices, etc. For instance, a stent for a child that grows with the child may be provided according to the disclosed technology. Such a stent could maintain its cylindrical shape throughout the growth of the child. As another example, a wind-load mitigation system for a building may maintain its aerodynamic properties throughout actuation.

Structures described herein may be actuated in any suitable manner according to their application. For example, a resilient shape morphing structure may be provided via spring joints (e.g., spring flexures, spring hinges, etc.). Such a structure might be transported/provided in a retracted configuration and allowed to expand via spring force. As another example, actuators may be coupled to various connection points to provide actuation along the structure's degree of freedom. For instance, FIG. 9 illustrates an example device 900 comprising structure 700 and an actuator 901. In this example, actuator 901 comprises a double-acting cylinder (e.g., a pneumatic cylinder or electric actuator) coupled to members 701, 702 at vertices O₃, K₃. For example, actuator 901 may provide an RRRP kinematic chain corresponding to the RRRP vector loop O₃P₈K₃. Actuation of this kinematic chain may translate to actuation of the entire structure 700. As another example, device 900 may comprise redundant actuators. The synchronized motion throughout a structure 700 may support synchronous control of such redundant actuators.

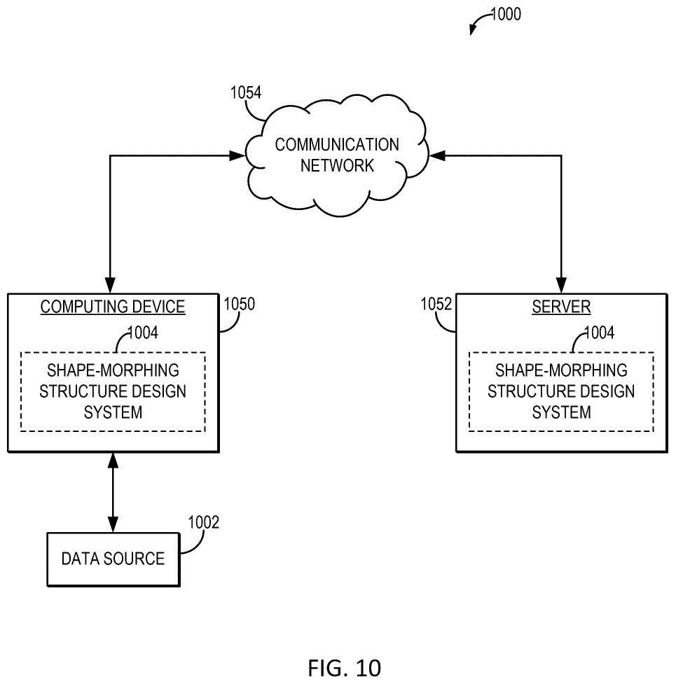

FIG. 10 shows an example of a system 1000 for designing shape morphing structures in accordance with some implementations described in the present disclosure. As shown in FIG. 10, a computing device 1050 can receive one or more types of data (e.g., a set of design constraints, a description of a particular underlying lattice, a target shape, an initial structure design, a structure design for modeling, etc.) from data source 1002.

In some embodiments, computing device 1050 can execute at least a portion of a shape-morphing structure design system 1004 to generate a structure design from data received from the data source 1002. For example, computing device 1050 may receive an outline for a target shape and generate an aperiodic tiled lattice to approximate the target shape. In this example, computing device 1050 may locate revolute joints at compatible lattice vertices to generate a framework for the structure. Such frameworks may incorporate revolute joints corresponding to multiple tiling orders, a single tiling order, or any combination. Computing device 1050 may then place/generate members in corresponding positions to link the revolute joints. For example, computing device 1050 may perform various layout optimization techniques, shape approximation techniques, etc. to generate a structure design meeting provided constraints. As another example, computing device 1050 may provide a design tool including an interface for a user to design a structure. For instance, computing device 1050 may provide an interface to display an underlying lattice and to allow a designer to place members at desired locations. In some examples, computing device 1050 may enforce compatibly conditions as described above. For instance, computing device 1050 may display a warning/error message if a user places a member in an incompatible location. As another example, computing device 1050 may display outlines or other indicators of valid member placement.

In further embodiments, computing device 1050 can execute system 1004 to model the motion of a structure design. For instance, as described with respect to FIG. 7, computing device 1050 may model the kinematics of an arbitrarily large structure may by computing the motion of a single OᵢPⱼKₗ loop, finding the complex factor, z, for each additional loop (yielding the rotation of link), and computing vector sums to determine the translation of each link. In further examples, a structure may comprise multiple kinematic chains having redundant parallel motion. In such examples, computing device 1050 may model the kinematics by identifying respective RRRP loops for each kinematic chain, finding respective sets of complex factors for the chains, and computing respective vector sums to determine the translation of each link of the independent chains.

Additionally or alternatively, in some embodiments, the computing device 1050 can communicate information about data received from the data source 1002 to a server 1052 over a communication network 1054, which can execute at least a portion of the shape-morphing structure design system 1004. In such embodiments, the server 1052 can return information to the computing device 1050 (and/or any other suitable computing device) indicative of an output of the shape-morphing structure design system system 1004.

In some embodiments, computing device 1050 and/or server 1052 can be any suitable computing device or combination of devices, such as a desktop computer, a laptop computer, a smartphone, a tablet computer, a wearable computer, a server computer, a virtual machine being executed by a physical computing device, and so on.

In some embodiments, data source 1002 can be any suitable source of data (e.g., constraint data, target data, underlying lattice data, partial design data, etc.), such as another computing device (e.g., a server/storage area network storing data), and so on. In some embodiments, data source 1002 can be local to computing device 1050. For example, data source 1002 can be incorporated with computing device 1050 (e.g., computing device 1050 can be configured as part of a device for measuring, recording, estimating, acquiring, or otherwise collecting or storing data). As another example, data source 1002 can be connected to computing device 1050 by a cable, a direct wireless link, and so on. Additionally or alternatively, in some embodiments, data source 1002 can be located locally and/or remotely from computing device 1050, and can communicate data to computing device 1050 (and/or server 1052) via a communication network (e.g., communication network 1054).

In some embodiments, communication network 1054 can be any suitable communication network or combination of communication networks. For example, communication network 1054 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 1054 can be a local area network, a wide area network, a public network (e.g., the Internet), a private or semi-private network (e.g., a corporate or university intranet), any other suitable type of network, or any suitable combination of networks. Communications links shown in FIG. 10 can each be any suitable communications link or combination of communications links, such as wired links, fiber optic links, Wi-Fi links, Bluetooth links, cellular links, and so on.

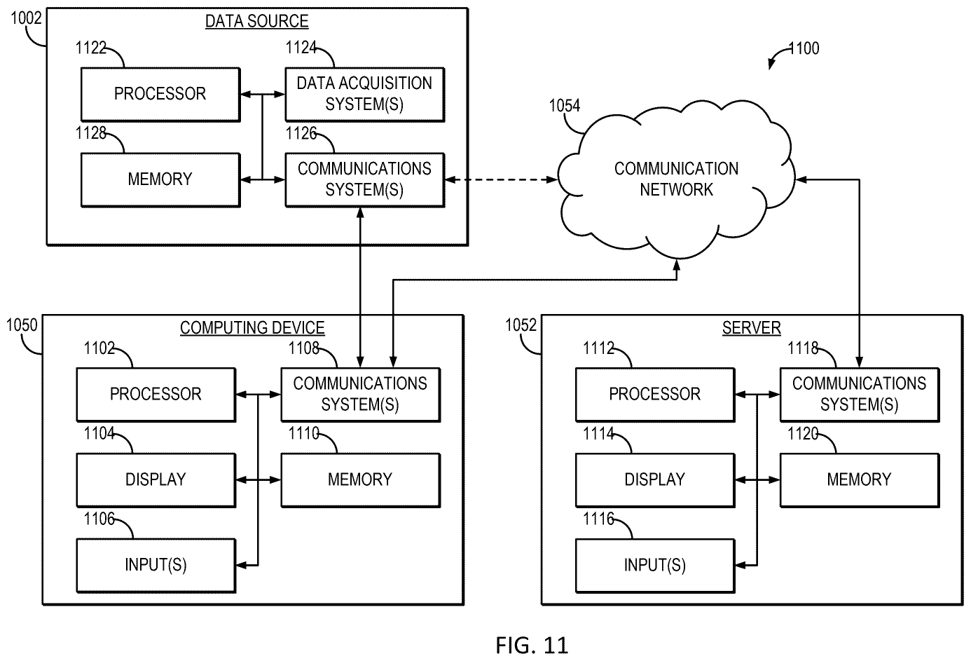

Referring now to FIG. 11, an example of hardware 1100 that can be used to implement data source 1002, computing device 1050, and server 1052 in accordance with some embodiments of the systems and methods described in the present disclosure is shown.

As shown in FIG. 11, in some embodiments, computing device 1050 can include a processor 1102, a display 1104, one or more inputs 1106, one or more communication systems 1108, and/or memory 1110. In some embodiments, processor 1102 can be any suitable hardware processor or combination of processors, such as a central processing unit (CPU), a graphics processing unit (GPU), and so on. In some embodiments, display 1104 can include any suitable display devices, such as a liquid crystal display (LCD) screen, a light-emitting diode (LED) display, an organic LED (OLED) display, an electrophoretic display (e.g., an “e-ink” display), a computer monitor, a touchscreen, a television, and so on. In some embodiments, inputs 1106 can include any suitable input devices and/or sensors that can be used to receive user input, such as a keyboard, a mouse, a touchscreen, a microphone, and so on.

In some embodiments, communications systems 1108 can include any suitable hardware, firmware, and/or software for communicating information over communication network 1054 and/or any other suitable communication networks. For example, communications systems 1108 can include one or more transceivers, one or more communication chips and/or chip sets, and so on. In a more particular example, communications systems 1108 can include hardware, firmware, and/or software that can be used to establish a Wi-Fi connection, a Bluetooth connection, a cellular connection, an Ethernet connection, and so on.

In some embodiments, memory 1110 can include any suitable storage device or devices that can be used to store instructions, values, data, or the like, that can be used, for example, by processor 1102 to present content using display 1104, to communicate with server 1052 via communications system(s) 1108, and so on. Memory 1110 can include any suitable volatile memory, non-volatile memory, storage, or any suitable combination thereof. For example, memory 1110 can include random-access memory (RAM), read-only memory (ROM), electrically programmable ROM (EPROM), electrically erasable ROM (EEPROM), other forms of volatile memory, other forms of non-volatile memory, one or more forms of semi-volatile memory, one or more flash drives, one or more hard disks, one or more solid state drives, one or more optical drives, and so on. In some embodiments, memory 1110 can have encoded thereon, or otherwise stored therein, a computer program for controlling operation of computing device 1050. In such embodiments, processor 1102 can execute at least a portion of the computer program to present content (e.g., images, user interfaces, graphics, tables, etc.), receive content from server 1052, transmit information to server 1052, and so on. For example, the processor 1102 and the memory 1110 can be configured to perform the methods described herein (e.g., the method of FIG. 9, the method of FIG. 10).

In some embodiments, server 1052 can include a processor 1112, a display 1114, one or more inputs 1116, one or more communications systems 1118, and/or memory 1120. In some embodiments, processor 1112 can be any suitable hardware processor or combination of processors, such as a CPU, a GPU, and so on. In some embodiments, display 1114 can include any suitable display devices, such as an LCD screen, LED display, OLED display, electrophoretic display, a computer monitor, a touchscreen, a television, and so on. In some embodiments, inputs 1116 can include any suitable input devices and/or sensors that can be used to receive user input, such as a keyboard, a mouse, a touchscreen, a microphone, and so on.

In some embodiments, communications systems 1118 can include any suitable hardware, firmware, and/or software for communicating information over communication network 1054 and/or any other suitable communication networks. For example, communications systems 1118 can include one or more transceivers, one or more communication chips and/or chip sets, and so on. In a more particular example, communications systems 1118 can include hardware, firmware, and/or software that can be used to establish a Wi-Fi connection, a Bluetooth connection, a cellular connection, an Ethernet connection, and so on.

In some embodiments, memory 1120 can include any suitable storage device or devices that can be used to store instructions, values, data, or the like, that can be used, for example, by processor 1112 to present content using display 1114, to communicate with one or more computing devices 1050, and so on. Memory 1120 can include any suitable volatile memory, non-volatile memory, storage, or any suitable combination thereof. For example, memory 1120 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 1120 can have encoded thereon a server program for controlling operation of server 1052. In such embodiments, processor 1112 can execute at least a portion of the server program to transmit information and/or content (e.g., data, images, a user interface) to one or more computing devices 1050, receive information and/or content from one or more computing devices 1050, receive instructions from one or more devices (e.g., a personal computer, a laptop computer, a tablet computer, a smartphone), and so on.

In some embodiments, the server 1052 is configured to perform the methods described in the present disclosure. For example, the processor 1112 and memory 1120 can be configured to perform the methods described herein.

In some embodiments, data source 1002 can include a processor 1122, one or more data acquisition systems 1124, one or more communications systems 1126, and/or memory 1128. In some embodiments, processor 1122 can be any suitable hardware processor or combination of processors, such as a CPU, a GPU, and so on.

Note that, although not shown, data source 1002 can include any suitable inputs and/or outputs. For example, data source 1002 can include input devices and/or sensors that can be used to receive user input, such as a keyboard, a mouse, a touchscreen, a microphone, a trackpad, a trackball, and so on. As another example, data source 1002 can include any suitable display devices, such as an LCD screen, an LED display, an OLED display, an electrophoretic display, a computer monitor, a touchscreen, a television, etc., one or more speakers, and so on.

In some embodiments, communications systems 1126 can include any suitable hardware, firmware, and/or software for communicating information to computing device 1050 (and, in some embodiments, over communication network 1054 and/or any other suitable communication networks). For example, communications systems 1126 can include one or more transceivers, one or more communication chips and/or chip sets, and so on. In a more particular example, communications systems 1126 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 1128 can include any suitable storage device or devices that can be used to store instructions, values, data, or the like, that can be used, for example, by processor 1122 to control the shape-morphing structure design system 1124, and/or receive data from the shape-morphing structure design system 1124; to generate structures from data; present content (e.g., data, images, a user structure design interface, etc.) using a display; communicate with one or more computing devices 1050; and so on. Memory 1128 can include any suitable volatile memory, non-volatile memory, storage, or any suitable combination thereof. For example, memory 1128 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 1128 can have encoded thereon, or otherwise stored therein, a program for controlling operation of data source 1002. In such embodiments, processor 1122 can execute at least a portion of the program to generate images, transmit information and/or content (e.g., data, images, a user interface) to one or more computing devices 1050, receive information and/or content from one or more computing devices 1050, receive instructions from one or more devices (e.g., a personal computer, a laptop computer, a tablet computer, a smartphone, etc.), and so on.

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

What is claimed is:

1. A structure comprising:
a plurality of first type members, each first type member corresponding to a respective first type vertex of an underlying aperiodic tiled lattice;
a plurality of second type members, each second type member corresponding to a respective second type vertex of the underlying aperiodic tiled lattice; and
a plurality of revolute joints corresponding to respective edges of the underlying aperiodic tiled lattice and connecting respective joint parts of pairs of members, each pair comprising a first type member and a second type member; wherein:
each respective revolute joint is located, with respect to a local position of the respective edge, at a first common normalized vector with respect to a local position of the respective first type vertex and at a second common normalized vector with respect to a local position of the respective second type vertex.

2. The structure of claim 1, wherein:
the underlying aperiodic tiled lattice comprises a dart and kite tiled lattice;
each first type member is a star member corresponding to a star vertex, an ace member corresponding to an ace vertex, a king member corresponding to a king vertex, or a queen member corresponding to a queen vertex; and
each second type member is a sun member corresponding to a sun vertex, a deuce member corresponding to a deuce vertex, or a jack member corresponding to a jack vertex.

3. The structure of claim 2, wherein:
any star member is connected to some deuce member;
any ace member is connected to some sun member, some jack member, or some deuce member;
any king member is connected to some jack member or some deuce member;
any queen member is connected to some sun member, some jack member, or some deuce member;
any sun member is connected to some star member or some queen member;
any deuce member is connected to some star member, some ace member, some king member, or some queen member; and
any jack member is connected to some ace member, some king member, or some queen member.

4. The structure of claim 1, wherein the first common normalized vector and the second common normalized vector varies during actuation of the plurality of revolute joints from a contracted configuration to an expanded configuration.

5. The structure of claim 1, wherein a first normalized length of the first common normalized vector is different than a second normalized length of the second common normalized vector.

6. The structure of claim 1, wherein the plurality of first type members comprises a first first type member corresponding to a first sized tiling of the underlying aperiodic tiled lattice and comprises a second first type member corresponding to a second sized tiling of the underlying aperiodic tiled lattice.

7. The structure of claim 1, wherein the plurality of revolute joints connects the plurality of first type members and the plurality of second type members in a kinematic chain comprising a plurality of parallel four-bar loops.

8. The structure of claim 7, wherein at least some of the parallel four-bar loops are redundant to others of the parallel four-bar loops.

9. The structure of claim 1, wherein at least a portion of the plurality of revolute joints comprise flexures or pin joints.

10. A device, comprising:
a structure, comprising:
a plurality of first type members, each first type member corresponding to a respective first type vertex of an underlying aperiodic tiled lattice;
a plurality of second type members, each second type member corresponding to a respective second type vertex of the underlying aperiodic tiled lattice; and
a plurality of revolute joints corresponding to respective edges of the underlying aperiodic tiled lattice and connecting respective joint parts of pairs of members, each pair comprising a first type member and a second type member;
wherein:
each respective revolute joint is located, with respect to a local position of the respective edge, at a first common normalized vector with respect to a local position of the respective first type vertex and at a second common normalized vector with respect to a local position of the respective second type vertex; and
an actuator coupled to the structure to actuator the plurality of revolute joints to transition the structure between a contracted configuration and an expanded configuration.

11. The device of claim 10, wherein:
the underlying aperiodic tiled array comprises a dart and kite tiled lattice;
each first type member is a star member corresponding to a star vertex, an ace member corresponding to an ace vertex, a king member corresponding to a king vertex, or a queen member corresponding to a queen vertex; and
each second type member is a sun member corresponding to a sun vertex, a deuce member corresponding to a deuce vertex, or a jack member corresponding to a jack vertex.

12. The device of claim 11, wherein:
any star member of the first plurality is connected to some deuce member of the second plurality;
any ace member of the first plurality is connected to some sun member, some jack member, or some deuce member of the second plurality;
any king member of the first plurality is connected to some jack member or some deuce member of the second plurality;
any queen member of the first plurality is connected to some sun member, some jack member, or some deuce member of the second plurality;
any sun member of the second plurality is connected to some star member or some queen member of the first plurality;
any deuce member of the second plurality is connected to some star member, some ace member, some king member, or some queen member of the first plurality;
any jack member of the second plurality is connected to some ace member, some king member, or some queen member of the first plurality.

13. The device of claim 10, wherein a first normalized length of the first common normalized vector is different than a second normalized length of the second common normalized vector.

14. The device of claim 10, wherein the plurality of first type members comprises a first first type member corresponding to a first sized tiling of the underlying lattice and comprises a second first type member corresponding to a second sized tiling of the underlying lattice.

15. The device of claim 10, wherein the plurality of revolute joints connects the plurality of first type members and the plurality of second type members in a kinematic chain comprising a plurality of parallel four-bar loops.

16. The device of claim 15, wherein at least some of the parallel four-bar loops are redundant to others of the parallel four-bar loops.

17. A method, comprising:
obtaining a description of an underlying aperiodic tiled lattice;
determining a structure shape corresponding to at least a portion of the underlying aperiodic tiled lattice;
selecting a plurality of first type vertexes of the underlying aperiodic tiled lattice for a plurality of first type members;
selecting a plurality of second type vertexes of the underlying aperiodic tiled lattice for a plurality of second type members;
locating a plurality of revolute joints to connect respective joint parts of pairs of members, each pair comprising a first type member and a second type member, the plurality of revolute joints corresponding to respective edges of the underlying aperiodic tiled lattice; wherein
each respective revolute joint is located, with respect to a local position of the respective edge, at a first common normalized vector with respect to a local position of the respective first type vertex and at a second common normalized vector with respect to a local position of the respective second type vertex; and
generating a design of a structure comprising the first type members and second type members connected by the plurality of revolute joints.

18. The method of claim 17, further comprising:
identifying a plurality of RRRP-type kinematic loops of the structure;
identifying a reference kinematic loop of the plurality of RRRP-type kinematic loops comprising a first reference vertex of the underlying aperiodic tiled lattice associated with a first type reference member, a second reference vertex of the underlying aperiodic tiled lattice associated with a second type reference member and a reference revolute joint connecting the first type reference member and the second type reference member;
identifying a rotation parameter for at least a subset of the plurality of RRRP-type kinematic loops with respect to the reference kinematic loop;
identifying translation parameters for at least a subset of the members of the plurality of RRRP-type kinematic loops with respect to the first type reference member or the second type reference member; and
modeling kinematics of the structure based on the reference kinematic loop, the rotation parameters, and the translation parameters.

19. The method of claim 17, wherein a first normalized length of the first common normalized vector is different than a second normalized length of the second common normalized vector.

20. The method of claim 17, wherein:
the underlying aperiodic tiled lattice comprises a dart and kite tiled lattice;
each first type member is a star member corresponding to a star vertex, an ace member corresponding to an ace vertex, a king member corresponding to a king vertex, or a queen member corresponding to a queen vertex; and
each second type member is a sun member corresponding to a sun vertex, a deuce member corresponding to a deuce vertex, or a jack member corresponding to a jack vertex.
